(19) United States
(12) Patent Application Publication
(10) Pub. No.: US 2025/0253572 A1
(43) Pub. Date: Aug. 7, 2025

(54) Terminal, Connector and Connector Assembly

(71) Applicants: Tyco Electronics Technology (SIP) Co., Ltd., Suzhou (CN); Tyco Electronics (Shanghai) Co., Ltd., Shanghai (CN)

(72) Inventors: Weidong Zhang, Shanghai (CN); Wenzheng Ma, Suzhou (CN); Lei Pan, Shanghai (CN); Hongyao (Harvey) Sheng, Suzhou (CN); Liang (Aiden) Chen, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 19/048,061

(22) Filed: Feb. 7, 2025

(30) Foreign Application Priority Data
Feb. 7, 2024 (CN) 202410176019.5

(51) Int. Cl. H01R 13/187

(52) U.S. Cl. CPC H01R 13/187

(57) ABSTRACT

A terminal includes a terminal plate having a top surface and a bottom surface opposite one another in a thickness direction and a slot formed in the top surface, a limit shell including a top plate located above the top surface of the terminal plate and a pair of side plates connected to the top plate, and an elastic contact member installed on the top surface of the terminal plate and facing the top plate of the limit shell. The terminal plate is a single terminal plate of the terminal. A pin is inserted into the slot in an interference fit manner to fix the limit shell to the terminal plate. The elastic contact member makes electrical contact with a mating terminal inserted between the elastic contact member and the top plate of the limit shell to electrically connect the terminal and the mating terminal.

### CROSS-REFERENCE TO RELATED APPLICATION

This application claims the benefit of the filing date under 35 U.S.C. § 119 (a)-(d) of Chinese Patent Application No. 202410176019.5, filed on Feb. 7, 2024.

### FIELD OF THE INVENTION

The present invention relates to a terminal, particularly to a terminal for a high voltage connector. In addition, the present invention also relates to a connector comprising the terminal and a connector assembly comprising the connector.

### BACKGROUND OF THE INVENTION

The terminal of a high-voltage connector typically includes a terminal body, a pair of elastic contacts, and a limit shell. The terminal body includes two terminal plates. There is a gap between the two terminal plates that allows for the insertion of a mating terminal. The pair of elastic contact members are set in the gap between two terminal plates and fixed to the inner surfaces of the two terminal plates respectively, used to clamp the mating terminal inserted between them to achieve electrical connection between the terminal and the mating terminal. The limit shell is fitted onto the two terminal plates of the terminal body, used to lock the terminal in the housing of the connector.

Due to the fact that the terminal body includes two terminal plates, the structure of the terminal is complex, the production cost is high, and the manufacturing difficulty is high. In addition, when vibration occurs, the gap between the two terminal plates will change, which can lead to poor electrical contact between the terminal and the mating terminal. Therefore, the terminal of existing high-voltage connectors is not suitable for vibration environments.

### SUMMARY OF THE INVENTION

A terminal includes a terminal plate having a top surface and a bottom surface opposite one another in a thickness direction and a slot formed in the top surface, a limit shell including a top plate located above the top surface of the terminal plate and a pair of side plates connected to the top plate, and an elastic contact member installed on the top surface of the terminal plate and facing the top plate of the limit shell. The terminal plate is a single terminal plate of the terminal. A pin is inserted into the slot in an interference fit manner to fix the limit shell to the terminal plate. The elastic contact member makes electrical contact with a mating terminal inserted between the elastic contact member and the top plate of the limit shell to electrically connect the terminal and the mating terminal.

### BRIEF DESCRIPTION OF THE DRAWINGS

The invention will now be described by way of example with reference to the accompanying figures, of which:

FIG. 1 shows an illustrative perspective view of a terminal according to an exemplary embodiment of the present invention when viewed from the front side;

FIG. 2 shows an illustrative perspective view of a terminal according to an exemplary embodiment of the present invention when viewed from the rear side;

FIG. 3 shows an illustrative exploded view of a terminal according to an exemplary embodiment of the present invention when viewed from the front side;

FIG. 4 shows an illustrative perspective view of the limit shell of a terminal according to an exemplary embodiment of the present invention; and

FIG. 5 shows an illustrative exploded view of a terminal according to an exemplary embodiment of the present invention when viewed from the rear.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details.

In other instances, well-known structures and devices are schematically shown in order to simplify the drawing.

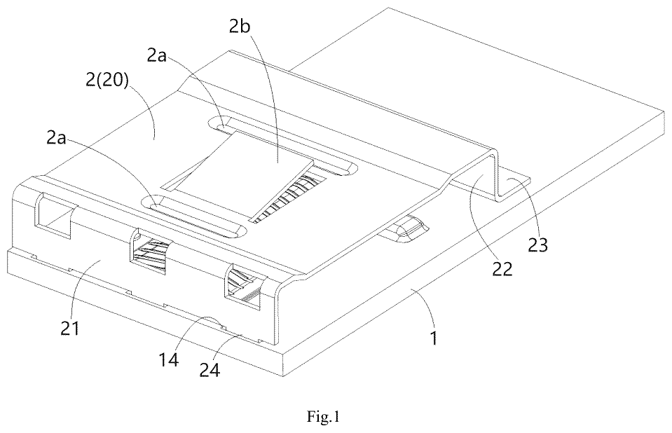

As shown in FIGS. 1 to 5, in an exemplary embodiment of the present invention, a terminal is disclosed. The terminal includes a single terminal plate 1, a limit shell 2, and an elastic contact member 3. The terminal plate 1 has top and bottom surfaces that are opposite in its thickness direction Z, and a slot 14 is formed in its top surface. The limit shell 2 includes a top plate 20 and a pair of side plates 21, 22. The top plate 20 is located above the top surface of terminal plate 1. The pair of side plates 21, 22 are connected to the top plate 20. The elastic contact member 3 is installed on the top surface of the terminal plate 1 and faces the top plate 20 of the limit shell 2. The elastic contact member 3 is used to make electrical contact with the mating terminal inserted between the elastic contact member 3 and the top plate 20 of the limit shell 2, in order to achieve electrical connection between the terminal and the mating terminal. A pin 24 is formed on the lower side of at least one of the pair of side plates 21, 22, and is inserted into the slot 14 in an interference fit manner to fix the limit shell 2 to the terminal plate 1.

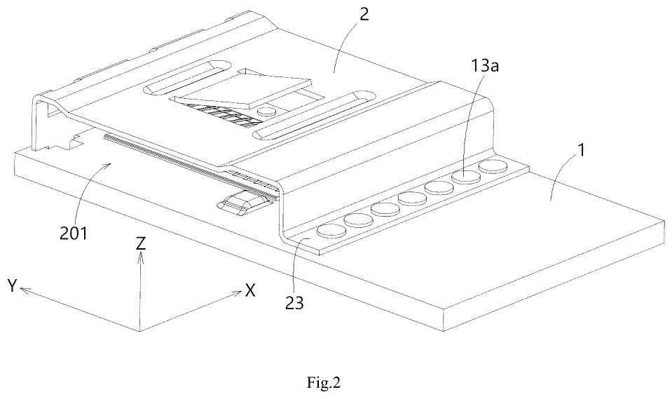

As shown in FIGS. 1 to 5, in the illustrated embodiment, the terminal plate 1 has a front end and a rear end that are opposite in its longitudinal direction Y. The limit shell 2 and the elastic contact member 3 are installed on the front part of the terminal plate 1. The limit shell 2 has two openings 201 opposite each other in the transverse direction X of the terminal plate 1, as shown in FIG. 2, to allow the mating terminal to be inserted between the elastic contact member 3 and the top plate 20 of the limit shell 2 along the transverse direction X of the terminal plate 1.

As shown in FIG. 1, in the illustrated embodiment, the pair of side plates 21, 22 of the limit shell 2 include a front side plate 21 and a rear side plate 22 that are opposite in the longitudinal direction Y of the terminal plate 1. The limit shell 2 also includes a riveting plate 23, which is connected to the lower side of the rear side plate 22 and bent vertically towards the rear. Pins 24 are formed on the lower side of the front plate 21, and the front plate 21 is fixed to the terminal plate 1 through the pins 24. The riveting plate 23 is riveted to the top surface of terminal plate 1, and the rear side plate 22 is fixed to terminal plate 1 through the riveting plate 23.

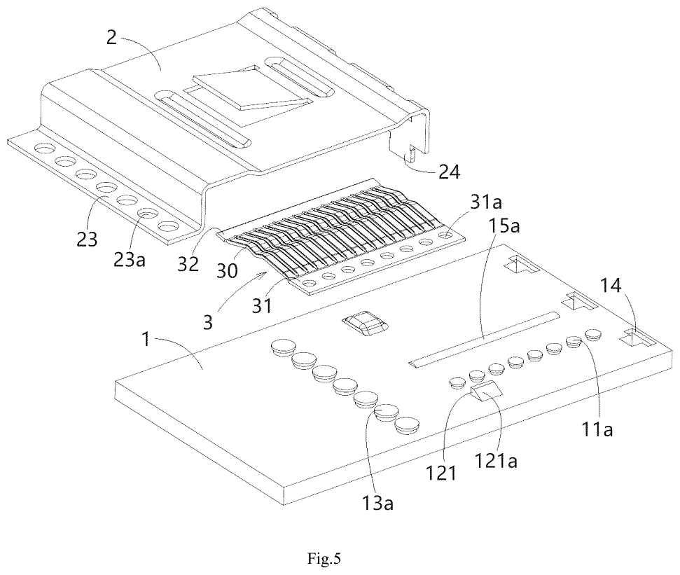

As shown in FIG. 5, in the illustrated embodiment, multiple first riveting holes 23a are formed in the riveting plate 23, and multiple first riveting posts 13a are formed on the terminal plate 1. The multiple first riveting posts 13a are respectively riveted into the multiple first riveting holes 23a to rivet the riveting plate 23 to the terminal plate 1, as shown in FIG. 2.

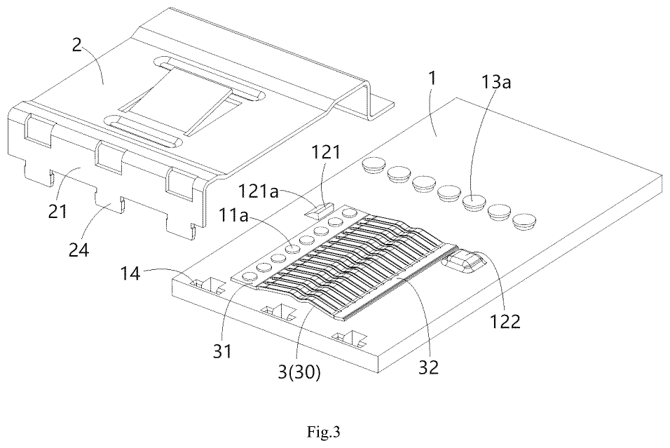

As shown in FIG. 3, in the illustrated embodiment, multiple pins 24 are formed on the lower side of the front side plate 21, and the multiple pins 24 are arranged in a row along the transverse X direction of the terminal plate 1. Multiple slots 14 are formed in the top surface of terminal plate 1 and arranged in a row along the transverse direction X of terminal plate 1. The pins 24 are respectively inserted into the slots 14 in an interference fit manner to fix the front side plate 21 to the terminal plate 1.

As shown in FIG. 2, in the illustrated embodiment, the slot 14 runs through the terminal plate 1 along the thickness direction Z of the terminal plate 1 and is adjacent to the front end surface of the terminal plate 1.

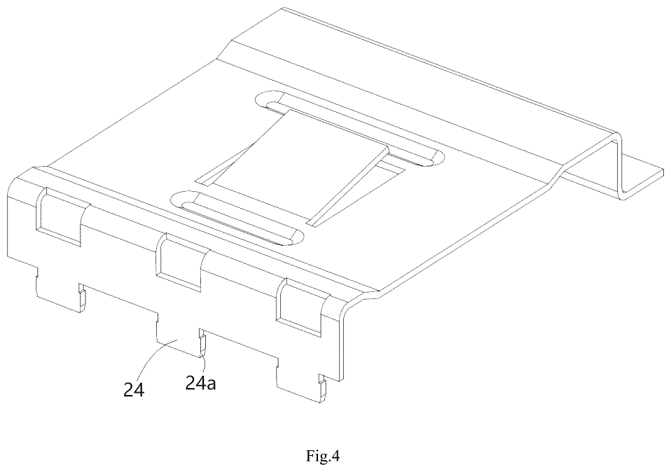

As shown in FIGS. 1 to 5, in the illustrated embodiment, the pin 24 and the slot 14 are flat, and guide slopes 24a are formed on both sides of the end of the pin 24, as shown in FIG. 4, to guide the insertion of the pin 24 into the slot 14.

As shown in FIG. 1, in the illustrated embodiment, at least one inwardly protruding rib 2a is formed on the top plate 20 of the limit shell 2. The rib 2a extends along the transverse direction X of the terminal plate 1 and is used to apply a predetermined pressure on the inserted mating terminal to ensure reliable electrical contact between the mating terminal and the elastic contact member 3. In the illustrated embodiment, two ribs 2a are formed on the top plate 20 of the limit shell 2, and the two ribs 2a are respectively located at the front and rear sides of the locking spring piece 2b.

As shown in FIG. 1, in the illustrated embodiment, a locking spring piece 2b is formed on the top plate 20 of the limit shell 2. The locking spring piece 2b extends obliquely towards the back and outward for engaging with the housing of the connector to lock the terminal in the housing of the connector.

As shown in FIG. 3, in the illustrated embodiment, the elastic contact member 3 includes multiple elastic arms 30 extending along the transverse direction X of the terminal plate 1, and the multiple elastic arms 30 are arranged in a row along the longitudinal direction Y of the terminal plate 1. The multiple elastic arms 30 of the elastic contact member 3 are used to simultaneously make electrical contact with the mating terminal inserted along the transverse direction X of the terminal plate 1.

As shown in FIG. 3, in the illustrated embodiment, the elastic contact member 3 further includes a first side edge part 31 and a second side edge part 32 that are opposite to each other in the transverse direction X of the terminal plate 1. The first side edge part 31 and the second side edge part 32 extend along the longitudinal direction Y of the terminal plate 1. Multiple elastic arms 30 are connected between the first side edge part 31 and the second side edge part 32. One of the first side edge part 31 and the second side edge part 32 is fixed to the terminal plate 1, while the other is slidably supported on the terminal plate 1.

As shown in FIGS. 3 and 5, in the illustrated embodiment, multiple second riveting holes 31 are formed in the first side edge part 31, and multiple second riveting posts 11a are formed on the terminal plate 1. The multiple second riveting posts 11a are respectively riveted into the multiple second riveting holes 31 to rivet the first side edge part 31 to the terminal plate 1.

As shown in FIG. 3, in the illustrated embodiment, a first support protrusion 121 and a second support protrusion 122 are formed on the top surface of the terminal plate 1. The first support protrusion 121 is adjacent to the first side edge part 31 of the elastic contact member 3, and the second support protrusion 122 is adjacent to the second side edge part 32 of the elastic contact member 3. The first support protrusion 121 and the second support protrusion 122 are used to support the inserted mating terminal to prevent the elastic arms 30 of the elastic contact member 3 from being excessively compressed by the mating terminal. In the illustrated embodiment, an inclined guide surface 121a is formed on the first support protrusion 121 for guiding the mating terminal to be inserted between the elastic contact member 3 and the top plate 20 of the limit shell 2.

As shown in FIG. 5, in the illustrated embodiment, a support rib 15a extending along its longitudinal direction Y is also formed on the terminal plate 1. The support rib 15a is located below the elastic arms 30 of the elastic contact member 3 and is used to support the elastic arms 30 of the elastic contact member 3 to prevent excessive deformation of the elastic arms 30 of the elastic contact member 3.

As shown in FIGS. 1 to 5, in the illustrated embodiment, the limit shell 2 is an integral stamped part.

In another exemplary embodiment of the present invention, a connector is also disclosed. The connector includes a housing and the above terminal inserted into the housing.

In another exemplary embodiment of the present invention, a connector assembly is also disclosed. The connector assembly includes the connector described above and a mating connector which is mated with the connector. The mating connector includes a mating housing and a mating terminal. The mating housing is used to mate with the housing of the connector. The mating terminal is inserted between the elastic contact member 3 of the connector and the top plate 20 of the limit shell 2, in order to make electrical contact with the elastic contact member 3 of the connector.

In the aforementioned exemplary embodiments of the present invention, the terminal body of the terminal only includes a single terminal plate, thus simplifying the structure of the terminal, reducing production costs and manufacturing difficulties. Moreover, the terminal of the present invention can also reliably make electrical contact with the mating terminal in a vibration environment.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a terminal plate having a top surface and a bottom surface opposite one another in a thickness direction and a slot formed in the top surface, the terminal plate is a single terminal plate of the terminal;
a limit shell including a top plate located above the top surface of the terminal plate and a pair of side plates connected to the top plate, a pin is formed on a lower side edge of at least one of the pair of side plates, the pin is inserted into the slot in an interference fit manner to fix the limit shell to the terminal plate; and
an elastic contact member installed on the top surface of the terminal plate and facing the top plate of the limit shell, the elastic contact member makes electrical contact with a mating terminal inserted between the elastic contact member and the top plate of the limit shell to electrically connect the terminal and the mating terminal.

2. The terminal according to claim 1, wherein the terminal plate has a front end and a rear end opposite one another in a longitudinal direction, the limit shell and the elastic contact member are installed on the front end of the terminal plate, the limit shell has a pair of opposite openings in a transverse direction of the terminal plate to allow the mating terminal to be inserted between the elastic contact member and the top plate of the limit shell along the transverse direction.

3. The terminal according to claim 2, wherein the pair of side plates of the limit shell include a front side plate and a rear side plate that are opposite to each other in the longitudinal direction of the terminal plate, the limit shell includes a riveting plate connected to a lower side of the rear side plate and bent towards a rear, the pin is formed on the lower side edge of the front side plate, the front side plate is fixed to the terminal plate by the pin, the riveting plate is riveted to the top surface of the terminal plate, and the rear side plate is fixed to the terminal plate through the riveting plate.

4. The terminal according to claim 3, wherein a plurality of first riveting holes are formed in the riveting plate, and a plurality of first riveting posts are formed on the terminal plate, the first riveting posts are respectively riveted into the first riveting holes to rivet the riveting plate to the terminal plate.

5. The terminal according to claim 3, wherein the pin is one of a plurality of pins formed on the lower side edge of the front side plate, the pins are arranged in a row along the transverse direction of the terminal plate, the slot is one of a plurality of slots formed in the top surface of the terminal plate and arranged in a row along the transverse direction of the terminal plate, the pins are respectively inserted into the slots in an interference fit manner to fix the front side plate to the terminal plate.

6. The terminal according to claim 5, wherein the slots run through the terminal plate along the thickness direction and are adjacent to a front end surface of the terminal plate.

7. The terminal according to claim 1, wherein the pin and the slot are flat in shape, a pair of guide slopes are formed on both sides of an end of the pin to guide the pin into the slot.

8. The terminal according to claim 2, wherein at least one rib that protrudes inwardly is formed on the top plate of the limit shell, the rib extends along the transverse direction of the terminal plate to apply a predetermined pressure on the mating terminal, ensuring reliable electrical contact between the mating terminal and the elastic contact member.

9. The terminal according to claim 8, wherein a locking spring piece is formed on the top plate of the limit shell, the locking spring piece extends obliquely towards a back and outward for engaging with a housing of a connector to lock the terminal in the housing of the connector.

10. The terminal according to claim 9, wherein a pair of ribs are formed on the top plate of the limit shell, the two ribs are respectively located at a front side and a rear side of the locking spring piece.

11. The terminal according to claim 2, wherein the elastic contact member has a plurality of elastic arms extending along the transverse direction of the terminal plate, the elastic arms are arranged in a row along the longitudinal direction of the terminal plate, the elastic arms of the elastic contact member simultaneously electrically contact the mating terminal inserted along the transverse direction of the terminal plate.

12. The terminal according to claim 11, wherein the elastic contact member has a first side edge part and a second side edge part opposite to each other in the transverse direction of the terminal plate, the first side edge part and the second side edge part extend along the longitudinal direction of the terminal plate, the elastic arms are connected between the first side edge part and the second side edge part, one of the first side edge part and the second side edge part is fixed to the terminal plate and the other of the first side edge part and the second side edge part is supported on the terminal plate in a sliding manner.

13. The terminal according to claim 12, wherein a plurality of second riveting holes are formed in the first side edge part, and a plurality of second riveting posts are formed on the terminal plate, the second riveting posts are respectively riveted into the second riveting holes to rivet the first side edge part to the terminal plate.

14. The terminal according to claim 12, wherein a first support protrusion and a second support protrusion are formed on the top surface of the terminal plate, the first support protrusion is adjacent to the first side edge part of the elastic contact member, and the second support protrusion is adjacent to the second side edge part of the elastic contact member, the first support protrusion and the second support protrusion support the mating terminal to prevent the elastic arms of the elastic contact member from being excessively compressed by the mating terminal.

15. The terminal according to claim 14, wherein an inclined guide surface is formed on the first support protrusion for guiding the mating terminal to be inserted between the elastic contact member and the top plate of the limit shell.

16. The terminal according to claim 12, wherein a support rib extending along the longitudinal direction is formed on the terminal plate, the support rib is located below the elastic arms of the elastic contact member to support the elastic arms of the elastic contact member and prevent excessive deformation of the elastic arms.

17. The terminal according to claim 1, wherein the limit shell is an integral stamped part.

18. A connector, comprising:
a housing; and
a terminal inserted into the housing, the terminal includes:
a terminal plate having a top surface and a bottom surface opposite one another in a thickness direction and a slot formed in the top surface, the terminal plate is a single terminal plate of the terminal;
a limit shell including a top plate located above the top surface of the terminal plate and a pair of side plates connected to the top plate, a pin is formed on a lower side edge of at least one of the pair of side plates, the pin is inserted into the slot in an interference fit manner to fix the limit shell to the terminal plate; and
an elastic contact member installed on the top surface of the terminal plate and facing the top plate of the limit shell, the elastic contact member makes electrical contact with a mating terminal inserted between the elastic contact member and the top plate of the limit shell to electrically connect the terminal and the mating terminal.

19. A connector assembly, comprising:
a connector including a housing and a terminal disposed in the housing, the terminal includes:
a terminal plate having a top surface and a bottom surface opposite one another in a thickness direction and a slot formed in the top surface, the terminal plate is a single terminal plate of the terminal;
a limit shell including a top plate located above the top surface of the terminal plate and a pair of side plates connected to the top plate, a pin is formed on a lower side edge of at least one of the pair of side plates, the pin is inserted into the slot in an interference fit manner to fix the limit shell to the terminal plate; and
an elastic contact member installed on the top surface of the terminal plate and facing the top plate of the limit shell; and
a mating connector mated with the connector, the mating connector includes:
a mating housing matable with the housing of the connector; and
a mating terminal inserted between the elastic contact member of the connector and the top plate of the limit shell to electrically contact the elastic contact member of the connector.
